(19) United States
(12) Patent Application Publication
(10) Pub. No.: US 2024/0019099 A1
(43) Pub. Date: Jan. 18, 2024

(54) OPERATING AND CERTIFYING AN ADAPTIVE DRIVING BEAM SYSTEM

(71) Applicant: GM GLOBAL TECHNOLOGY OPERATIONS LLC, DETROIT, MI (US)

(72) Inventors: Albert Ekladyous, Shelby Twp., MI (US); Michael K. Larsen, Warren, MI (US)

(21) Appl. No.: 17/863,578

(22) Filed: Jul. 13, 2022

(51) Int. Cl. F21S 41/60

(52) U.S. Cl. CPC F21S 41/60; F21W 2102/10

(57) ABSTRACT

An adaptive driving beam system is provided. The operating an adaptive driving beam system is operated by defining an output field of the adaptive driving beam system, wherein the output field is divided into a plurality of areas and outputting a field of light into each of the plurality of areas, wherein a brightness of the field of light in each area is individually controlled. The plurality of areas include a first unreduced intensity area, a first reduced intensity area, and a first transition area disposed between the first unreduced intensity area and the first reduced intensity area. The first transition area is a horizontal band having a width of at most one degree of vertical angle.

### INTRODUCTION

The disclosure relates to Adaptive Driving Beam (ADB) systems. More specifically, the disclosure relates to methods for operating and certifying an ADB system.

Recently, ADB systems have been developed for use in automobiles to provide a long-range light beam for forward visibility. ADB systems automatically modify portions of the projected light to reduce glare to traffic participants on an ongoing, dynamic basis. In general, ADB systems use sensors to obtain environmental data of the automobile and direct the beam of light only where it is needed. ADB systems are configured to change the brightness and shape of the beam using various technologies. ADB systems also eliminate the need for drivers to switch between low beams and high beams.

The operation of ADB systems are governed by various governmental regulations across the globe, such as the Department of Transportation's National Highway Traffic Safety Administration in the United States.

### SUMMARY

In one exemplary embodiment, a method for operating an adaptive driving beam system of a vehicle is provided. The method includes defining an output field of the adaptive driving beam system, wherein the output field is divided into a plurality of areas and outputting a field of light into each of the plurality of areas, wherein a brightness of the field of light in each area is individually controlled. The plurality of areas include a first unreduced intensity area, a first reduced intensity area, and a first transition area disposed between the first unreduced intensity area and the first reduced intensity area. The first transition area is a horizontal band having a width of at most one degree of vertical angle.

In addition to the one or more features described herein each of the plurality of areas are defined by a range of horizontal angles and a range of vertical angles.

In addition to the one or more features described herein the brightness of the field of light in each area does not exceed a maximum threshold value.

In addition to the one or more features described herein the plurality of areas further include a second unreduced intensity area, a second reduced intensity area, and a second transition area disposed between the second unreduced intensity area and the second reduced intensity area.

In addition to the one or more features described herein the second unreduced intensity area, the second reduced intensity area, and the second transition area are defined as having a horizontal angle of greater than zero degrees.

In addition to the one or more features described herein the second transition area is defined as having a vertical angle of greater than one-half degree and less than one and a half degrees.

In addition to the one or more features described herein the brightness of the field of light in the first unreduced intensity area and the second unreduced intensity area conform with photometric intensity requirements of Table XVIII of Federal Motor Vehicle Safety Standards section 108.

In addition to the one or more features described herein the brightness of the field of light in the first reduced intensity area and the second reduced intensity area conform with photometric intensity requirements of Table XIX of Federal Motor Vehicle Safety Standards section 108.

In addition to the one or more features described herein the first unreduced intensity area, the first reduced intensity area, and the first transition area are defined as having a horizontal angle of less than zero degrees.

In addition to the one or more features described herein the first transition area is defined as having a vertical angle of greater than zero degrees and less than one degree.

In one exemplary embodiment, a method for certifying an adaptive driving beam system of a vehicle is provided. The method includes defining an output field of the adaptive driving beam system, wherein the output field is divided into a plurality of areas. The plurality of areas include a first unreduced intensity area, a first reduced intensity area, and a first transition area disposed between the first unreduced intensity area and the first reduced intensity area and a second unreduced intensity area, a second reduced intensity area, and a second transition area disposed between the second unreduced intensity area and the second reduced intensity area. The first transition area and the second transition area are horizontal bands having a width of at most one degree of vertical angle.

In addition to the one or more features described herein the brightness of the field of light in the first unreduced intensity area and the second unreduced intensity area conform with photometric intensity requirements of Table XVIII of Federal Motor Vehicle Safety Standards section 108.

In addition to the one or more features described herein the brightness of the field of light in the first reduced intensity area and the second reduced intensity area conform with photometric intensity requirements of Table XIX of Federal Motor Vehicle Safety Standards section 108.

In addition to the one or more features described herein the brightness of the field of light in each area does not exceed a maximum threshold value.

In addition to the one or more features described herein the second unreduced intensity area, the second reduced intensity area, and the second transition area are defined as having a horizontal angle of greater than zero degrees.

In addition to the one or more features described herein the second transition area is defined as having a vertical angle of greater than one-half degree and less than one and a half degrees.

In addition to the one or more features described herein the first unreduced intensity area, the first reduced intensity area, and the first transition area are defined as having a horizontal angle of less than zero degrees.

In addition to the one or more features described herein the first transition area is defined as having a vertical angle of greater than zero degrees and less than one degree.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A is a schematic diagram illustrating a side view of a vehicle with an adaptive driving beam system in accordance with an exemplary embodiment;

FIG. 1B is a schematic diagram illustrating atop view of a vehicle with an adaptive driving beam system in accordance with an exemplary embodiment;

FIG. 2 is a schematic diagram illustrating the operation of an adaptive driving beam system in accordance with an exemplary embodiment;

FIG. 3A is a graph illustrating photometric intensity requirements for an unreduced intensity area as defined by Table XVIII of Federal Motor Vehicle Safety Standards section 108;

FIG. 3B is a graph illustrating photometric intensity requirements for a reduced intensity area as defined by Table XIX of Federal Motor Vehicle Safety Standards section 108;

FIG. 4A is a graph illustrating an output field of an adaptive driving beam system in accordance with an exemplary embodiment;

FIG. 4B is a graph illustrating another output field of an adaptive driving beam system in accordance with an exemplary embodiment;

FIG. 5A is a graph illustrating a mapping of the transition areas in the output filed of the adaptive driving beam system with the unreduced intensity area as defined by Table XVIII of Federal Motor Vehicle Safety Standards section 108;

FIG. 5B is a graph illustrating a mapping of the transition areas in the output filed of the adaptive driving beam system with reduced intensity area as defined by Table XIX of Federal Motor Vehicle Safety Standards section 108; and

FIG. 6 is a flowchart illustrating a method for operating an adaptive driving beam system in accordance with an exemplary embodiment.

### DETAILED DESCRIPTION

The following description is merely exemplary in nature and is not intended to limit the present disclosure, its application or uses. Various embodiments of the disclosure are described herein with reference to the related drawings. Alternative embodiments of the disclosure can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

Turning now to an overview of the aspects of the disclosure, embodiments of the disclosure include an adaptive driving beam system that has an output field into which it is capable of outputting light. The output field of the adaptive driving beam system is divided into a plurality of areas and a brightness of the light emitted into each area is individually controlled by the adaptive driving beam system. In exemplary embodiments, the plurality of areas include unreduced intensity areas, reduced intensity areas, and transition areas disposed between the unreduced intensity areas and the reduced intensity areas. In exemplary embodiments, the transition areas are horizontal bands having a width of at most one degree of vertical angle. In exemplary embodiments, the adaptive driving beam system is configured to comply with the photometric intensity requirements as defined by the Federal Motor Vehicle Safety Standards section 108.

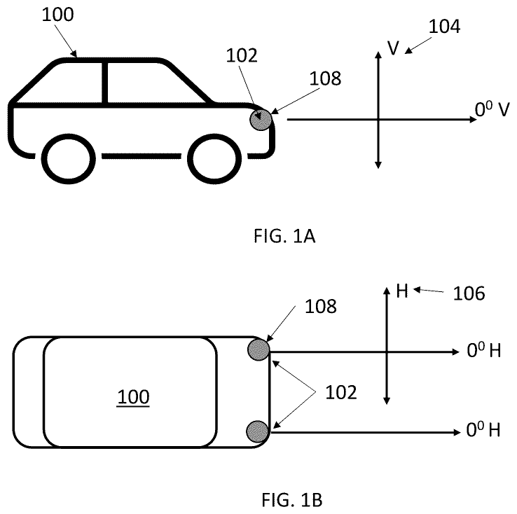

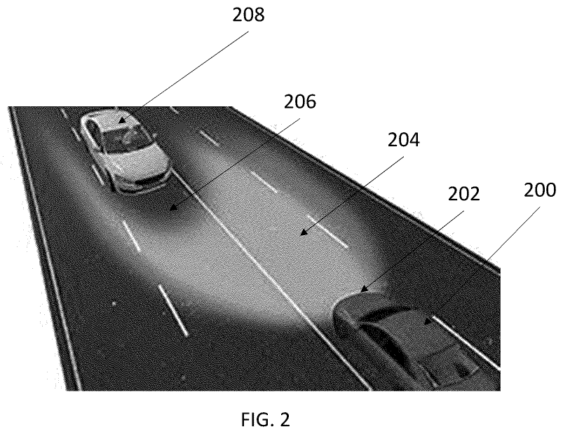

Referring now to FIGS. 1A and 1B, schematic diagrams illustrating a vehicle 100 with an adaptive driving beam system 102 in accordance with an exemplary embodiment are shown. The adaptive driving beam system 102 is configured to emit light in an output field in front of the vehicle 100. The output field is divided into a plurality of areas that are defined by a range of horizontal angles 106 and a range of vertical angles 104.

As best illustrated in FIG. 1A, the vertical angle 104 is measured in a first direction normal to the direction of travel of the vehicle 100 and has a measurement of zero degrees at a plane substantially parallel to the ground. The horizontal angle 106 is measured in a second direction normal to travel of the vehicle 100 and the first direction. As best illustrated in FIG. 1B, the horizontal angle 106 has a measurement of zero degrees at a plane substantially normal to the direction of travel of the vehicle 100. A portion of the field of light emitted by the adaptive driving beam system 102 can be identified by a combination of the horizontal angle 106 and the vertical angle 104. The axis and intersection of the H-V planes go through center of each headlamp 108 of the driving beam system 102, as opposed to the center of the vehicle.

For example, a portion of the field of light emitted by the adaptive driving beam system 102 directly in front of the vehicle would be characterized by a horizontal angle 106 of zero and a portion of the field of light emitted by the adaptive driving beam system 102 to the left of the vehicle would be characterized by a horizontal angle 106 of less than zero. Similarly, a portion of the field of light emitted by the adaptive driving beam system 102 directed above a plane substantially parallel to the ground would be characterized by a vertical angle 104 of greater than zero and a portion of the field of light emitted by the adaptive driving beam system 102 directed below a plane substantially parallel to the ground would be characterized by a vertical angle 104 of less than zero. In one embodiment, the vertical angle 104 can be measured in degrees up/down and the horizontal angle 106 can be measured in degrees left/right, rather than in positive and negative numbers.

Referring now to FIG. 2, a schematic diagram illustrating the operation of an adaptive driving beam system in accordance with an exemplary embodiment is shown. As illustrated, a vehicle 200 is configured with an adaptive driving beam system 202. The adaptive driving beam system 202 is configured to emit a field of light having an unreduced intensity area 204 and a reduced intensity area 206. In exemplary embodiments, the adaptive driving beam system 202 is configured to detect a presence of an oncoming vehicle 208 and to adapt the field of light such that the reduced intensity area 206 includes an area in which the oncoming vehicle 208 is located.

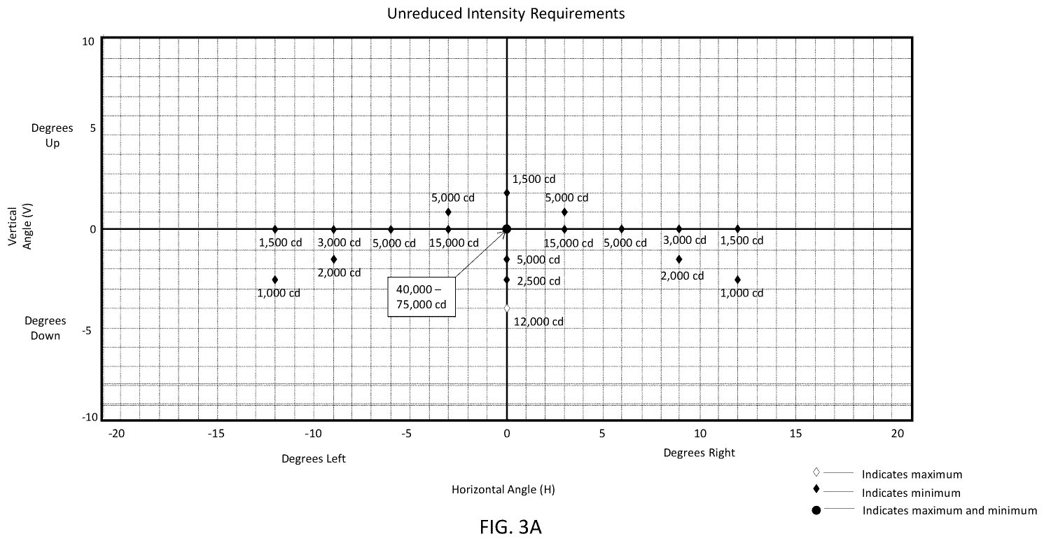

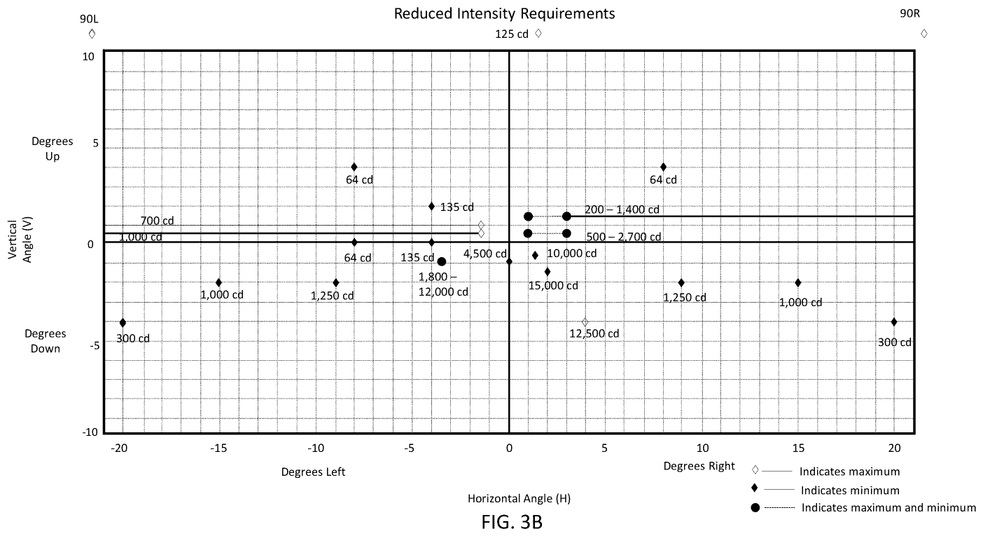

Recently, the United States Department of Transportation's National Highway Traffic Safety Administration released an update to the Federal Motor Vehicle Safety Standard (FMVSS) section 108 which regulates all automotive lighting, signaling, and reflective devices in the United States to include regulations governing the use and certification of adaptive driving beam systems. FMVSS section 108 includes detailed photometric intensity requirements for the operation of adaptive driving beam systems in both unreduced intensity areas and reduced intensity areas. FIG. 3A is a graph illustrating the photometric intensity requirements for an unreduced intensity area as defined by Table XVIII of Federal Motor Vehicle Safety Standards section 108. FIG. 3B is a graph illustrating the photometric intensity requirements for a reduced intensity area as defined by Table XIX of Federal Motor Vehicle Safety Standards section 108. FMVSS section 108 further defines an allowed transition area between the unreduced intensity areas and reduced intensity areas in which the photometric intensity requirements of Table XVIII and Table XIX do not apply. The only photometric intensity requirement in the transition area is that a maximum intensity of 75,000 candela (cd) cannot be exceeded.

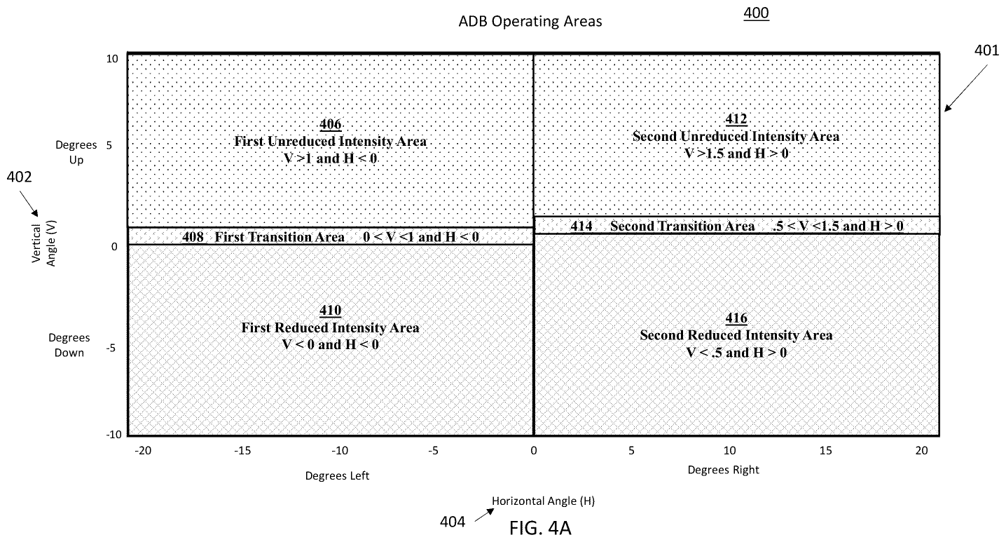

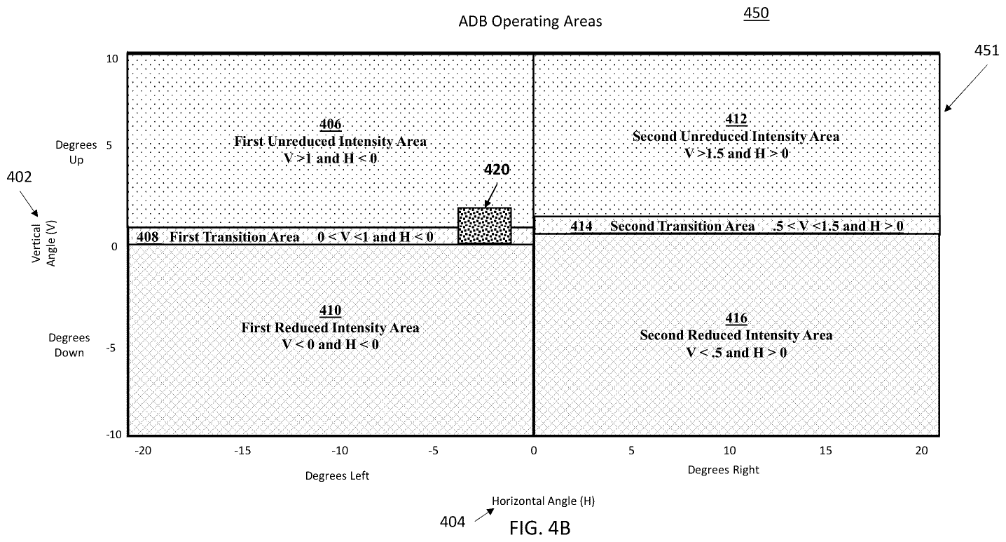

Referring now to FIG. 4A, a graph 400 illustrating an output field 401 of an adaptive driving beam system in accordance with an exemplary embodiment is shown. As illustrated, the output field 401 is divided into a plurality of areas that are defined based on a range of vertical angles 402 and a range of horizontal angles 404. The plurality of areas include a first unreduced intensity area 406, a first reduced intensity area 410, and a first transition area 408 disposed between the first unreduced intensity area 406 and the first reduced intensity area 410.

In one embodiment, the first unreduced intensity area 406 is defined as having a vertical angle of greater than one degree and a horizontal angle of less than zero degrees. The first reduced intensity area 410 is defined as having a vertical angle of less than zero degrees and a horizontal angle of less than zero degrees. The first transition area 408 is defined as having a vertical angle of less than one degree and greater than zero degrees and a horizontal angle of less than zero degrees.

The plurality of areas also include a second unreduced intensity area 412, a second reduced intensity area 416, and a second transition area 414 disposed between the second unreduced intensity area 412 and the second reduced intensity area 416. In one embodiment, the second unreduced intensity area 412 is defined as having a vertical angle of greater than one and a half degrees and a horizontal angle of greater than zero degrees. The second reduced intensity area 416 is defined as having a vertical angle of less than one-half of a degree and a horizontal angle of greater than zero degrees. The second transition area 414 is defined as having a vertical angle of less than one and a half degrees and greater than one-half degree and a horizontal angle of greater than zero degrees.

Referring now to FIG. 4B, a graph 450 illustrating an output field 451 of an adaptive driving beam system in accordance with an exemplary embodiment is shown. The output field 451 is substantially similar to the output field 401 shown in FIG. 4A but the output field 451 also includes a third reduced intensity area 420. The third reduced intensity area 420 is an example of a shadow area that is produced to reduce the glare of the headlamps to an oncoming car, such as is shown in FIG. 2. In exemplary embodiments, the adaptive driving beam system is configured to create one or more reduced intensity area 420 based on the detection of oncoming cars or other environmental conditions. In the embodiment illustrated, the output field 451 includes a single reduced intensity area 420 that extends from a vertical angle of greater than zero degrees to a vertical angle of two degrees, or two degrees up, and from a horizontal angle of negative four degrees, or four degrees left, to a horizontal angle of negative one degree, or one degree left. As will be appreciated by those of ordinary skill in the art, the number, location and dimensions of the reduced intensity areas 420, will vary based on the operating environment of the adaptive driving beam system.

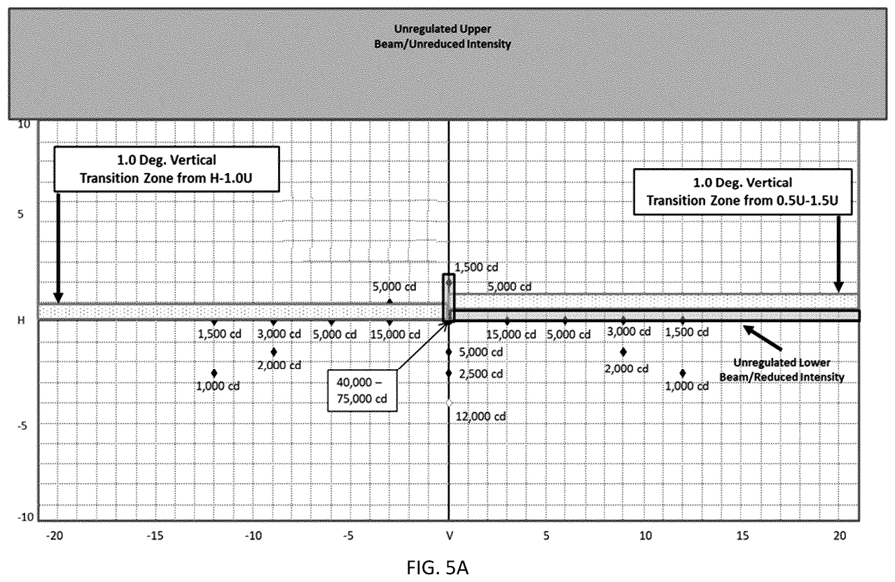

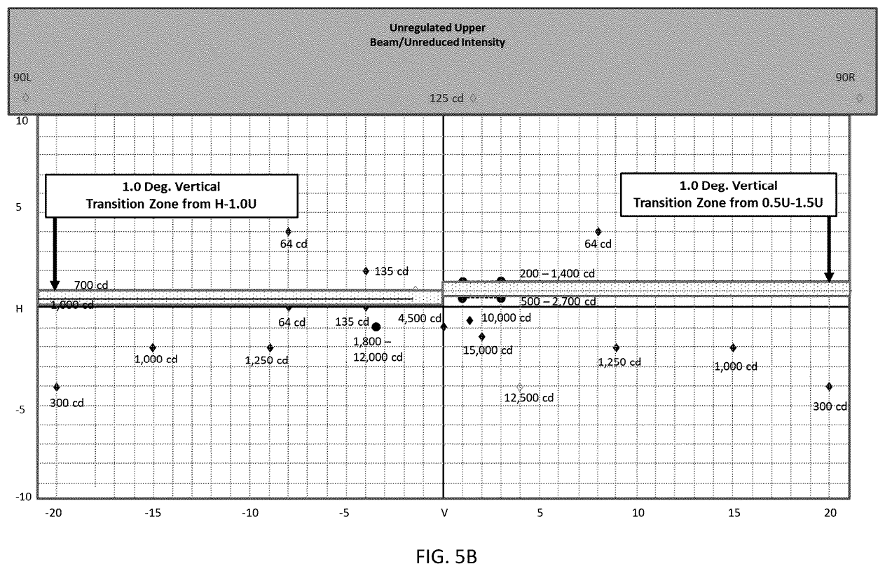

Referring now to FIG. 5A, a graph illustrating a mapping of the transition areas in the output filed of the adaptive driving beam system with the unreduced intensity area as defined by Table XVIII of Federal Motor Vehicle Safety Standards section 108 is shown. As illustrated, several of the photometric intensity requirements defined by Table XVIII of Federal Motor Vehicle Safety Standards section 108 fall within the illustrated transition areas. As a result, these photometric intensity requirements will not need to be met to certify that the driving beam system complies with FMVSS section 108.

Referring now to FIG. 5B, a graph illustrating a mapping of the transition areas in the output filed of the adaptive driving beam system with reduced intensity area as defined by Table XIX of Federal Motor Vehicle Safety Standards section 108. As illustrated, several of the photometric intensity requirements defined by Table XIX of Federal Motor Vehicle Safety Standards section 108 fall within the illustrated transition areas. As a result, these photometric intensity requirements will not need to be met to certify that the driving beam system complies with FMVSS section 108. In exemplary embodiments, the line scans specified by Federal Motor Vehicle Safety Standards section 108 fall within the transition areas and are therefore excluded from the photometric intensity requirements, with the exception that a maximum intensity of 75,000 candelas (cd) cannot be exceeded in the transition areas.

In exemplary embodiments, the transition areas are horizontal bands having a width of at most one degree of vertical angle. In some embodiments, the first transition area is a horizontal band having a center line at one-half degree of vertical angle and the second transition area is a horizontal band having a center line at one degree of vertical angle.

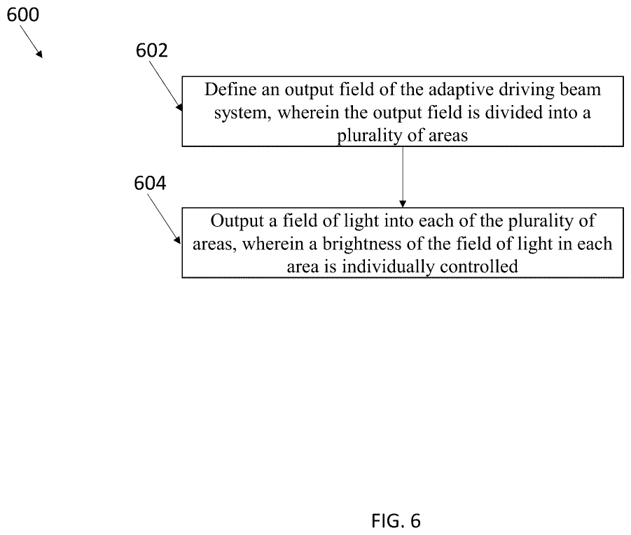

Referring now to FIG. 6, a flowchart illustrating a method 600 operating an adaptive driving beam system of a vehicle in accordance with an exemplary embodiment is shown. In exemplary embodiments, the method 600 is performed by a processor configured to operate the adaptive driving beam system. As shown at block 602, the method 600 includes defining an output field of the adaptive driving beam system, wherein the output field is divided into a plurality of areas. The method 600 also includes outputting a field of light into each of the plurality of areas, wherein the brightness of the field of light in each area is individually controlled, as shown at block 604. In exemplary embodiments, the plurality of areas include a first unreduced intensity area, a first reduced intensity area, and a first transition area disposed between the first unreduced intensity area and the first reduced intensity area.

In exemplary embodiments, each the plurality of areas are defined by a range of horizontal angles and a range of vertical angles. The first transition area is a horizontal band having a width of at most one degree of vertical angle. In one embodiment, the first unreduced intensity area, the first reduced intensity area, and the first transition area are defined as having a horizontal angle of less than zero degrees and the first transition area is defined as having a vertical angle of greater than zero degrees and less than one degree.

In exemplary embodiments, the plurality of areas further include a second unreduced intensity area, a second reduced intensity area, and a second transition area disposed between the second unreduced intensity area and the second reduced intensity area. In one embodiment, the second unreduced intensity area, the second reduced intensity area, and the second transition area are defined as having a horizontal angle of greater than zero degrees and the second transition area is defined as having a vertical angle of greater than one-half degrees and less than one and a half degrees.

In exemplary embodiments, the brightness of the field of light in the first unreduced intensity area and the second unreduced intensity area conform with photometric intensity requirements of Table XVIII of Federal Motor Vehicle Safety Standards section 108. In exemplary embodiments, the brightness of the field of light in the first reduced intensity area and the second reduced intensity area conform with photometric intensity requirements of Table XIX of Federal Motor Vehicle Safety Standards section 108.

In exemplary embodiments, ADB systems configured with the plurality of areas as described above retain the safety performance aspects of ADB systems used in other regulatory regions outside of the United States while still complying with the ADB lamp lab regulatory requirements prescribed in FMVSS 108. In addition, the disclosed ADB systems also greatly simplify the certification process of an ADB lamp to FMVSS 108 by eliminating the need to test every permutation of an ADB headlamp.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, (i.e., one, two, three, four, etc.). The terms “a plurality” may be understood to include any integer number greater than or equal to two, (i.e., two, three, four, five, etc.). The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of 8% or 5%, or 2% of a given value.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for operating an adaptive driving beam system of a vehicle, the method comprising:
defining an output field of the adaptive driving beam system, wherein the output field is divided into a plurality of areas; and
outputting a field of light into each of the plurality of areas, wherein a brightness of the field of light in each area is individually controlled,
wherein the plurality of areas include a first unreduced intensity area, a first reduced intensity area, and a first transition area disposed between the first unreduced intensity area and the first reduced intensity area, and
wherein the first transition area is a horizontal band having a width of at most one degree of vertical angle.

2. The method of claim 1, wherein each the plurality of areas are defined by a range of horizontal angles and a range of vertical angles.

3. The method of claim 1, wherein the brightness of the field of light in each area does not exceed a maximum threshold value.

4. The method of claim 1, wherein the plurality of areas further include a second unreduced intensity area, a second reduced intensity area, and a second transition area disposed between the second unreduced intensity area and the second reduced intensity area.

5. The method of claim 4, wherein the second unreduced intensity area, the second reduced intensity area, and the second transition area are defined as having a horizontal angle of greater than zero degrees.

6. The method of claim 4, wherein the second transition area is defined as having a vertical angle of greater than one-half degree and less than one and a half degrees.

7. The method of claim 4, wherein the brightness of the field of light in the first unreduced intensity area and the second unreduced intensity area conform with photometric intensity requirements of Table XVIII of Federal Motor Vehicle Safety Standards section 108.

8. The method of claim 4, wherein the brightness of the field of light in the first reduced intensity area and the second reduced intensity area conform with photometric intensity requirements of Table XIX of Federal Motor Vehicle Safety Standards section 108.

9. The method of claim 1, wherein the first unreduced intensity area, the first reduced intensity area, and the first transition area are defined as having a horizontal angle of less than zero degrees.

10. The method of claim 1, wherein the first transition area is defined as having a vertical angle of greater than zero degrees and less than one degree.

11. A method for certifying an adaptive driving beam system of a vehicle, the method comprising:
defining an output field of the adaptive driving beam system, wherein the output field is divided into a plurality of areas including:
a first unreduced intensity area, a first reduced intensity area, and a first transition area disposed between the first unreduced intensity area and the first reduced intensity area; and
a second unreduced intensity area, a second reduced intensity area, and a second transition area disposed between the second unreduced intensity area and the second reduced intensity area,
wherein the first transition area and the second transition area are horizontal bands having a width of at most one degree of vertical angle.

12. The method of claim 11, wherein a brightness of the field of light in the first unreduced intensity area and the second unreduced intensity area conform with photometric intensity requirements of Table XVIII of Federal Motor Vehicle Safety Standards section 108.

13. The method of claim 11, wherein a brightness of the field of light in the first reduced intensity area and the second reduced intensity area conform with photometric intensity requirements of Table XIX of Federal Motor Vehicle Safety Standards section 108.

14. The method of claim 11, wherein a brightness of the field of light in each area does not exceed a maximum threshold value.

15. The method of claim 11, wherein the second unreduced intensity area, the second reduced intensity area, and the second transition area are defined as having a horizontal angle of greater than zero degrees.

16. The method of claim 11, wherein the second transition area is defined as having a vertical angle of greater than one-half degree and less than one and a half degrees.

17. The method of claim 11, wherein the first unreduced intensity area, the first reduced intensity area, and the first transition area are defined as having a horizontal angle of less than zero degrees.

18. The method of claim 11, wherein the first transition area is defined as having a vertical angle of greater than zero degrees and less than one degree.
